(19) United States
(12) Patent Application Publication
(10) Pub. No.: US 2014/0297603 A1
(43) Pub. Date: Oct. 2, 2014

(54) METHOD AND APPARATUS FOR DEDUPLICATION OF REPLICATED FILE

(71) Applicant: ELECTRONICS AND TELECOMMUNICATIONS RESEARCH INSTITUTE, Daejeon (KR)

(72) Inventors: Young-Chang KIM, Songkang-dong (KR); Hong Yeon KIM, Daejeon (KR); Young Kyun KIM, Daejeon (KR)

(21) Appl. No.: 13/927,520

(22) Filed: Jun. 26, 2013

(30) Foreign Application Priority Data
Mar. 27, 2013 (KR) 10-2013-0033054

(51) Int. Cl. G06F 17/30

(52) U.S. Cl. CPC G06F 17/30159
USPC 707/692

(57) ABSTRACT

A replicated file deduplication apparatus generates a hash key of a requested data block, determines whether the same data block as the requested data block exists in data blocks of a replicated image file that is derived from the same golden image file as the requested data block using the hash key of the requested data block, and records, if the same data block as the requested data block exists, information of a chunk in which the same data block as the requested data block is stored at a layout of the requested data block.

### CROSS-REFERENCE TO RELATED APPLICATION

This application claims priority to and the benefit of Korean Patent Application No. 10-2013-0033054 filed in the Korean Intellectual Property Office on Mar. 27, 2013, the entire contents of which are incorporated herein by reference.

### BACKGROUND OF THE INVENTION

(a) Field of the Invention

The present invention relates to a method and apparatus for deduplicating a replicated file. More particularly, the present invention relates to a method and apparatus for deduplicating a replicated file for improving efficiency of replicated image storage space of a virtual machine.

(b) Description of the Related Art

In a virtual desktop environment, in order to shorten a virtual machine generation time and to increase storage space efficiency, a method of generating a golden image of a common operating system that a user uses, generating a replicated image using technology such as a linked clone or a zero copy clone, and storing only data blocks that are different from a golden image on a user's virtual machine basis is provided.

However, after initial replication, as a replicated image size increases with change data accumulation on a user basis, even if changed data is overlapped on a replicated image basis like a security update, there is a drawback that changed data is overlappingly stored on a replicated image basis.

As a method of solving the drawback, there is deduplication technology that enhances actual storage space use efficiency by detecting overlapped portions between different files and by removing the overlapped portions.

U.S. Patent Laid-Open Publication No. 2012-0167087 discloses “Apparatus and method for driving virtual machine and method for deduplication of virtual machine image”. This technology divides and stores a virtual machine image into a chunk of a previously defined size and gives an identifier to the chunk. When a storage request for a chunk that is not stored in a storage unit occurs, an identifier of the requested chunk is generated and is given to the chunk, and it is checked whether the same identifier exists in identifiers of a previously stored chunk. If the same identifier exists, the chunk having the same identifier is regarded as the same chunk, and the access frequency number of a corresponding chunk identifier is increased and is registered at a virtual machine image, and a corresponding chunk is referred to. Thereby, storage of a duplicate chunk may be avoided.

In this case, when it is assumed that a total size of virtual images that are stored at storage is 1 TB, a size of a chunk is 4 KB, and an identifier length is 4 bytes, a size of an identifier table necessary for a duplication check is 1 TB/4 KB* 32 bytes (256 bits) equals about 8 GB, and as the number of virtual machines increases, a situation in which a table is not maintained within a memory occurs. Therefore, only some tables are maintained in the memory and the remaining tables should be stored at a hard disk drive (HDD), and thus write performance is deteriorated with an increase of a duplication check time according to an identifier search due to disk access. Therefore, a method of reducing the size of a chunk identifier table necessary for a duplication check is requested.

Korean Patent Laid-Open Publication No. 10-2012-0074817 discloses “Mapping management system and method for improving deduplication performance of storage apparatus”. This technology relates to a method of recording a plurality of data at a mapping table when the plurality of data are overlapped, storing mapping information at the mapping table to refer to stored data instead of storing new data when the new data is duplicated by the stored data, and reducing the number of operations necessary for data storage. However, because the technology should maintain mapping information of the entire storage space, there is a drawback that the above problem equally occurs.

### SUMMARY OF THE INVENTION

The present invention has been made in an effort to provide a method and apparatus for deduplicating a replicated file having advantages of improving replicated image storage space efficiency of a virtual machine.

An exemplary embodiment of the present invention provides a deduplication apparatus of a replicated image file that is derived from a golden image file of a virtual machine. The deduplication apparatus includes a deduplication table and a deduplication controller. The deduplication table maps a chunk identifier and a hash key of replicated image files on a golden image file basis. The deduplication controller searches for whether the same data block as the requested data block exists in a data block of replicated image files of the same golden image file as a data block in which writing is requested with reference to the deduplication table, and performs deduplication processing if the same data block as the requested data block exists.

The deduplication table may include: a sharing image identifier table that stores a sharing image identifier representing a golden image file; and a plurality of hash key tables that map a chunk identifier and a hash key of each data block of replicated image files on a sharing image identifier basis. The deduplication controller may determine that the same file block as the requested file block exists when a chunk identifier that is mapped to a hash key of the requested file block exists with reference to a hash key table corresponding to a sharing image identifier of the requested data block.

The apparatus may further include a metadata controller. The metadata controller may manage metadata of the golden image file and the replicated image file. The metadata may include a sharing image identifier for identifying the golden image file and a data block layout representing a chunk of each data block of the golden image file and the replicated image file. The deduplication controller may acquire a sharing image identifier of the requested data block from the metadata controller.

The metadata may be generated when the golden image file and the replicated image file are generated.

The deduplication controller may acquire a position of a layout of the requested data block from the metadata controller if the same data block as the requested data block exists, and may record a chunk identifier that is mapped to the hash key of the requested data block at a position of the acquired layout.

The deduplication controller may map a new chunk identifier to a hash key of the requested data block if the same data block as the requested data block does not exist, and may register the new chunk identifier at the deduplication table.

The deduplication controller may acquire a new chunk identifier from the metadata controller if the same data block as the requested data block does not exist and forward the new chunk identifier and the requested data block to a chunk server, and the requested data block may be stored to correspond to the new chunk identifier by the chunk server.

The apparatus may further include a hash key generator that generates a hash key of the requested file block using hardware acceleration.

Another embodiment of the present invention provides a method in which a deduplication apparatus of a replicated file deduplicates a replicated image file that is derived from a golden image file of a virtual machine. The method may include: generating a hash key of a data block in which writing is requested; determining whether the same data block as the requested data block exists in data blocks of replicated image files that are derived from the same golden image file as the requested data block using a hash key of the requested data block; and performing deduplication processing if the same data block as the requested data block exists.

The determining of whether the same data block as the requested data block exists may include: acquiring a sharing image identifier of a golden image file corresponding to the requested data block; determining whether a chunk identifier that is mapped to a hash key of the requested data block exists with reference to a hash key table corresponding to the acquired sharing image identifier in a plurality of hash key tables that map a chunk identifier and a hash key of each data block of replicated image files on a sharing image identifier basis; and determining, if a chunk identifier that is mapped to a hash key of the requested data block exists, that the same data block as the requested data block exists.

The performing of deduplication processing may include acquiring a position of a layout of the requested data block, and recording a chunk identifier that is mapped to a hash key of the requested data block at the position of a layout of the requested data block.

The determining of whether the same data block as the requested data block exists may further include determining, if a chunk identifier that is mapped to the hash key of the requested data block does not exist, that the same data block as the requested data block does not exist.

The method may further include mapping, if the same data block as the requested data block does not exist, a new chunk identifier to the hash key of the requested data block and registering the new chunk identifier at the hash key table.

The method may further include forwarding, if the same data block as the requested data block does not exist, a new chunk identifier and the requested data block to a chunk server. The requested data block may be stored to correspond to the new chunk identifier by the chunk server.

The generating of a hash key may include generating a hash key of the requested file block using hardware acceleration.

### BRIEF DESCRIPTION OF THE DRAWINGS

FIG. 1 is a diagram illustrating an example of a deduplication system in a virtual desktop environment to which a replicated file deduplication apparatus is applied according to an exemplary embodiment of the present invention.

FIG. 2 is a diagram illustrating an example of a deduplication server of FIG. 1.

FIG. 3 is a diagram illustrating an example of a chunk server of FIG. 1.

FIG. 4 is a diagram illustrating an example of metadata that a metadata controller of FIG. 2 manages.

FIG. 5 is a diagram illustrating an example of a deduplication table of FIG. 2.

FIG. 6 is a flowchart illustrating a deduplication method in a deduplication server according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for deduplicating a replicated file according to an exemplary embodiment of the present invention will be described in detail with reference to the drawings.

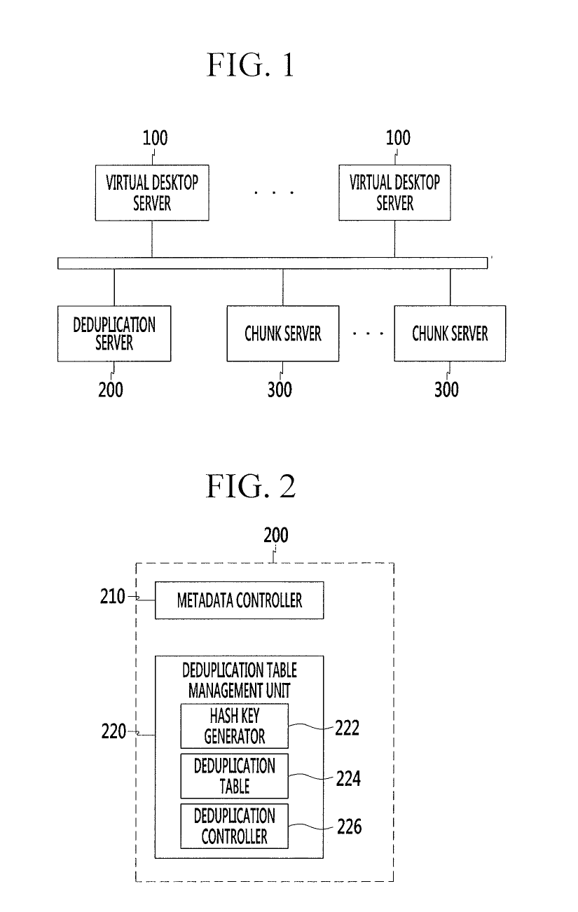

FIG. 1 is a diagram illustrating an example of a deduplication system in a virtual desktop environment to which a replicated file deduplication apparatus is applied according to an exemplary embodiment of the present invention.

Referring to FIG. 1, the deduplication system includes at least one virtual desktop server 100, a replicated file deduplication apparatus (hereinafter, for convenience, referred to as a “deduplication server”) 200, and at least one chunk server 300.

When a user's virtual machine is executed, the virtual desktop server 100 forwards an input/output request for a virtual machine image to the deduplication server 200.

The deduplication server 200 receives an input/output request from the virtual desktop server 100 and processes the input/output request.

When a write request for a data block of a file occurs, the deduplication server 200 performs a duplication check of the requested data block, and if the requested data block is duplicate data, the deduplication server 200 does not store data but records and updates chunk information of the stored same data at a layout of a corresponding data block. Further, if the requested data block is not replicated data, the deduplication server 200 registers information of a chunk of the requested data block at a deduplication table and stores the corresponding data block at the chunk server 300.

The chunk server 300 performs actual input/output management of chunks corresponding to a data block of a file. The file is divided into a data block of a fixed size. In this case, the data block is stored at a chunk.

FIG. 2 is a diagram illustrating an example of a deduplication server of FIG. 1.

Referring to FIG. 2, the deduplication server 200 includes a metadata controller 210 and a deduplication table management unit 220.

The metadata controller 210 manages a golden image file of a virtual machine and metadata of a replicated image file that is derived from the golden image file.

The deduplication table management unit 220 includes a hash key generator 222, a deduplication table 224, and a deduplication controller 226.

When a write request has occurred from the virtual desktop server 100, the deduplication table management unit 220 performs a duplication check of a requested data block and prevents the same data from being stored. For this purpose, the hash key generator 222 generates a hash key of the requested data block, and the deduplication controller 226 performs a duplication check for determining whether the same data block exists at the deduplication table 224 using the generated hash key. In this case, the hash key generator 222 accelerates a hash key calculation speed using hardware acceleration such as AES-NI. The deduplication table 224 manages a hash key of each data block of replicated image files for deduplication of replicated image files on a golden image file basis and a chunk identifier that is mapped to the hash key. The deduplication controller 226 determines whether a replicated data block exists by checking the corresponding deduplication table 224 with a hash key of a requested data block, and if a replicated data block does not exist, the deduplication controller 226 stores a corresponding data block at the chunk server 300, and if a replicated data block exists, the deduplication controller 226 changes a layout of a requested data block.

Such a deduplication server 200 may form a plurality of physical servers according to a system structure, and may form a deduplication table of each golden image file on a server basis.

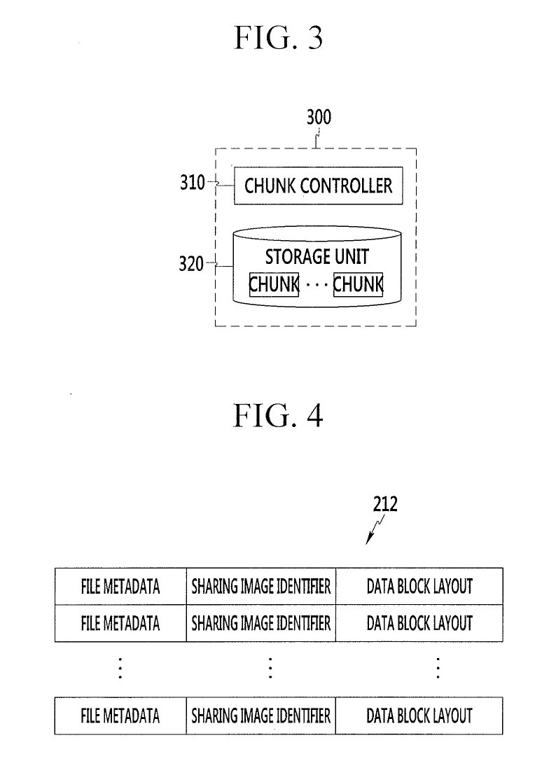

FIG. 3 is a diagram illustrating an example of a chunk server of FIG. 1.

Referring to FIG. 3, the chunk server 300 includes a chunk controller 310 and a storage unit 320.

The chunk controller 310 stores and reads a chunk corresponding to a chunk identifier of the requested data block. When a read request occurs, the chunk controller 310 reads and returns a chunk corresponding to the chunk identifier from the storage unit 320, and when a write request occurs, the chunk controller 310 generates a new chunk corresponding to the chunk identifier and stores corresponding data at the storage unit 320.

The storage unit 320 stores a chunk corresponding to a chunk identifier.

FIG. 4 is a diagram illustrating an example of metadata that the metadata controller of FIG. 2 manages.

Referring to FIG. 4, metadata 212 that the metadata controller 210 manages includes file metadata corresponding to general file information such as a name, a size, a generation time, and ownership of a file, a sharing image identifier indicating a golden image of a corresponding file, and a data block layout indicating a chunk in which each data block of a corresponding file is stored. When a golden image of a virtual machine and a replicated image thereof are generated, metadata of such file is generated, and when a corresponding image is deleted, metadata is deleted.

When a read request is received, the metadata controller 210 acquires a chunk identifier of a corresponding data block from layout information of metadata of a requested data block, and forwards a chunk identifier to the chunk server 300 that stores a chunk corresponding to the acquired chunk identifier. Therefore, the chunk server 300 reads and returns a chunk corresponding to the chunk identifier.

When a write request is received, the metadata controller 210 provides information of necessary metadata according to whether a requested data block is duplicated data to the deduplication server 200.

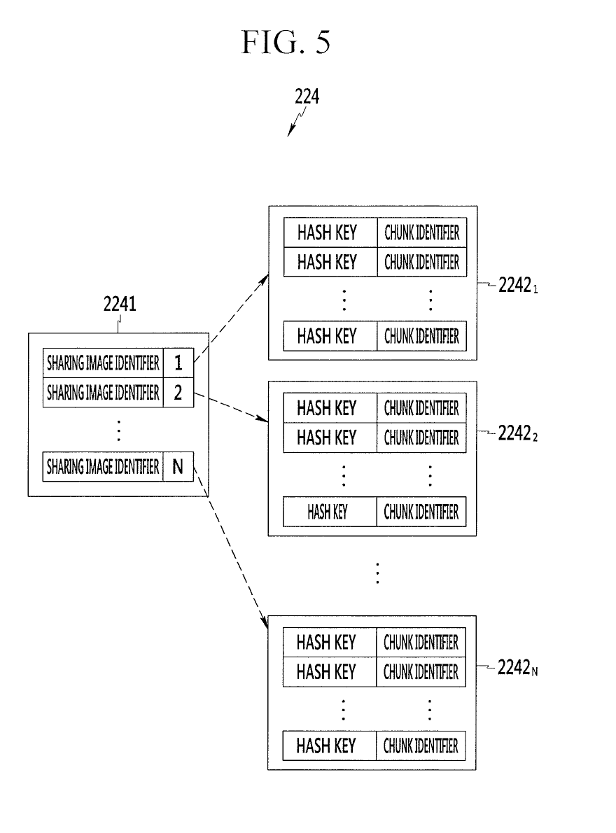

FIG. 5 is a diagram illustrating an example of the deduplication table of FIG. 2.

Referring to FIG. 5, the deduplication table 224 includes a sharing image identifier table 2241 and a plurality of hash tables 2242₁-2242_{N}.

The sharing image identifier table 2241 stores and manages a sharing image identifier indicating a golden image.

Hash tables 2242₁-2242_{N} exist on a sharing image identifier basis of a golden image that a replicated image of each virtual machine shares. Deduplication is performed only within a replicated image group in which a sharing image identifier is the same.

The hash tables 2242₁-2242_{N} each map, store, and manage a hash key of a data block of replicated image files that are derived from a corresponding golden image file and a chunk identifier corresponding to the hash key.

When a write request is input from a user, the virtual desktop server 100 forwards the write request to the deduplication table management unit 220.

The hash key generator 222 of the deduplication table management unit 220 generates a hash key of the requested data block. The deduplication controller 226 searches for the deduplication table 224 using the generated hash key. In this case, the deduplication controller 226 first searches for an entry, i.e., a hash table reference representing a hash table of a sharing image identifier of a golden image file corresponding to a data block that is requested from the sharing image identifier table 2241. Next, the deduplication controller 226 determines whether a chunk identifier that is mapped to a hash key of a data block that is requested from a hash table corresponding to the found entry among the hash tables 2242₁-2242_{N} exists.

If a chunk identifier that is mapped to the hash key of the requested data block exists, the deduplication controller 226 determines that the requested data block is duplicated data and performs a deduplication processing, and if a chunk identifier that is mapped to the hash key of the requested data block does not exist, the deduplication controller 226 registers a new chunk identifier at the hash table 2242 and stores a new chunk of the requested data block at the chunk server 300.

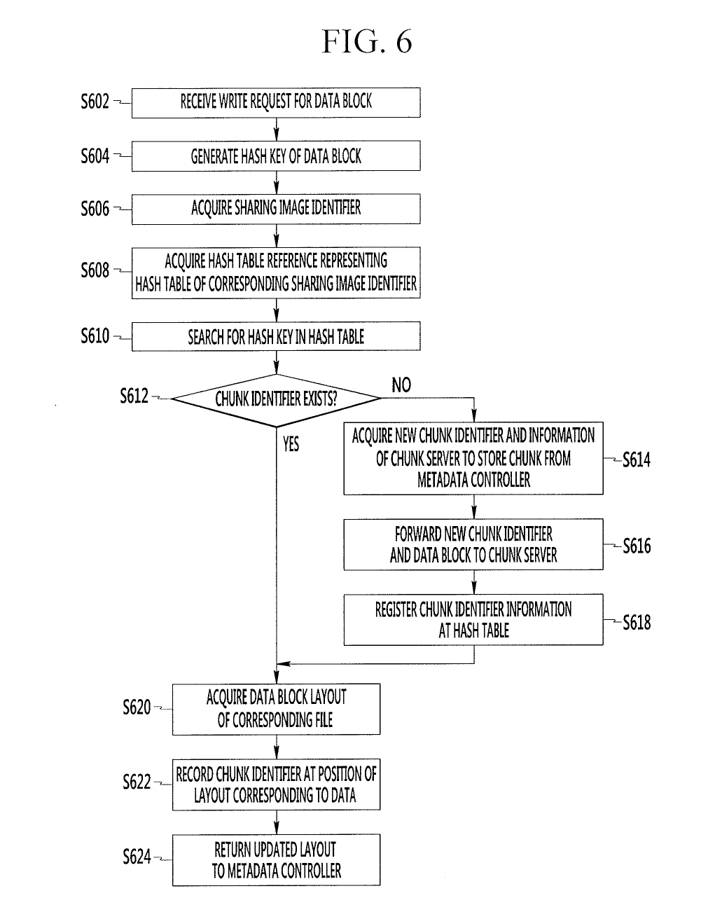

FIG. 6 is a flowchart illustrating a deduplication method in a deduplication server according to an exemplary embodiment of the present invention.

Referring to FIG. 6, the deduplication server 200 receives a write request of a data block of a file from the virtual desktop server 100 (S602).

The hash key generator 222 of the deduplication table management unit 220 generates a hash key, using hardware acceleration such as AES-NI, of the requested data block (S604).

The metadata controller 210 searches for metadata of a replicated image file corresponding to the requested file block and acquires a sharing image identifier corresponding to the requested file block (S606).

The deduplication controller 226 of the deduplication table management unit 220 searches for the sharing image identifier table 2241 using the acquired sharing image identifier, and acquires a hash table reference representing a hash table of a corresponding sharing image identifier (S608).

The deduplication controller 226 searches for a hash key in a hash table corresponding to the acquired hash table reference (S610), and determines whether a chunk identifier that is mapped to the found hash key exists (S612).

If a chunk identifier that is mapped to a hash key exists, the deduplication controller 226 determines that the requested data block is duplicated data and performs a deduplication process, and if a chunk identifier that is mapped to a hash key does not exist, the deduplication controller 226 determines the requested data block to be a new chunk and stores the chunk.

First, if a chunk identifier that is mapped to the hash key does not exist, the deduplication controller 226 acquires a new chunk identifier and information of the chunk server 300 to store a corresponding chunk from the metadata controller 210 (S614).

The deduplication controller 226 forwards a chunk identifier that is acquired from the metadata controller 210 and the requested data block to a corresponding chunk server 300 (S616), and the corresponding chunk server stores a new chunk corresponding to the requested data block.

The deduplication controller 226 registers a newly generated chunk identifier together with the hash key of the requested data block at a corresponding hash table (S618). Thereby, when a storage request of the same block data occurs later, the deduplication controller 226 prevents duplication storage of data with reference to a corresponding hash table.

Next, the deduplication controller 226 acquires a data block layout of a file corresponding to the requested data block from the metadata controller 210 (S620), and records a newly generated chunk identifier at a position of a layout corresponding to the requested data block (S622).

Finally, the deduplication controller 226 returns an updated layout to the metadata controller 210 (S624). The metadata controller 210 records the updated layout.

If a chunk identifier that is mapped to the hash key of the requested data block exists, the deduplication controller 226 acquires a data block layout of a file corresponding to the requested data block from the metadata controller 210 (S620).

The deduplication controller 226 records a chunk identifier that is found at the hash table at a layout position corresponding to the requested data block (S622).

Finally, the deduplication controller 226 returns the updated layout to the metadata controller 210 (S624).

According to an exemplary embodiment of the present invention, in a virtual desktop environment, actual use efficiency of replicated image storage space of a virtual machine can be increased, an in-line deduplication time is shortened compared with an existing method, and write performance is thus improved.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A deduplication apparatus of a replicated image file that is derived from a golden image file of a virtual machine, the deduplication apparatus comprising:
a deduplication table that maps a chunk identifier and a hash key of replicated image files on a golden image file basis; and
a deduplication controller that searches for whether the same data block as the requested data block exists in a data block of replicated image files of the same golden image file as a data block in which writing is requested with reference to the deduplication table, and that performs a deduplication processing if the same data block as the requested data block exists.

2. The apparatus of claim 1, wherein the deduplication table comprises:
a sharing image identifier table that stores a sharing image identifier representing a golden image file; and
a plurality of hash key tables that map a chunk identifier and a hash key of each data block of replicated image files on a sharing image identifier basis,
wherein the deduplication controller determines that the same file block as a requested file block exists when a chunk identifier that is mapped to a hash key of the requested file block exists with reference to a hash key table corresponding to a sharing image identifier of the requested data block.

3. The apparatus of claim 2, further comprising a metadata controller that manages metadata of the golden image file and the replicated image file,
wherein the metadata comprises a sharing image identifier for identifying the golden image file and a data block layout representing a chunk of each data block of the golden image file and the replicated image file, and
the deduplication controller acquires a sharing image identifier of the requested data block from the metadata controller.

4. The apparatus of claim 3, wherein the metadata is generated when the golden image file and the replicated image file are generated.

5. The apparatus of claim 3, wherein the deduplication controller acquires a position of a layout of the requested data block from the metadata controller if the same data block as the requested data block exists, and records a chunk identifier that is mapped to the hash key of the requested data block at a position of the acquired layout.

6. The apparatus of claim 3, wherein the deduplication controller maps a new chunk identifier to a hash key of the requested data block if the same data block as the requested data block does not exist, and registers the new chunk identifier at the deduplication table.

7. The apparatus of claim 6, wherein the deduplication controller acquires a new chunk identifier from the metadata controller if the same data block as the requested data block does not exist and forwards the new chunk identifier and the requested data block to a chunk server, and
the requested data block is stored to correspond to the new chunk identifier by the chunk server.

8. The apparatus of claim 2, further comprising a hash key generator that generates a hash key of the requested file block using hardware acceleration.

9. A method in which a deduplication apparatus of a replicated file deduplicates a replicated image file that is derived from a golden image file of a virtual machine, the method comprising:
generating a hash key of a data block in which writing is requested;
determining whether the same data block as the requested data block exists in data blocks of replicated image files that are derived from the same golden image file as the requested data block using a hash key of the requested data block; and
performing deduplication processing if the same data block as the requested data block exists.

10. The method of claim 9, wherein the determining of whether the same data block as the requested data block exists comprises:
acquiring a sharing image identifier of a golden image file corresponding to the requested data block;
determining whether a chunk identifier that is mapped to a hash key of the requested data block exists with reference to a hash key table corresponding to the acquired sharing image identifier in a plurality of hash key tables that map a chunk identifier and a hash key of each data block of replicated image files on a sharing image identifier basis; and
determining, if a chunk identifier that is mapped to a hash key of the requested data block exists, that the same data block as the requested data block exists.

11. The method of claim 10, wherein the performing of a deduplication processing comprises:
acquiring a position of a layout of the requested data block; and
recording a chunk identifier that is mapped to a hash key of the requested data block at the position of a layout of the requested data block.

12. The method of claim 10, wherein the determining of whether the same data block as the requested data block exists further comprises determining, if a chunk identifier that is mapped to the hash key of the requested data block does not exist, that the same data block as the requested data block does not exist.

13. The method of claim 9, further comprising mapping, if the same data block as the requested data block does not exist, a new chunk identifier to the hash key of the requested data block and registering the new chunk identifier at the hash key table.

14. The method of claim 13, further comprising forwarding, if the same data block as the requested data block does not exist, a new chunk identifier and the requested data block to a chunk server,
wherein the requested data block is stored to correspond to the new chunk identifier by the chunk server.

15. The method of claim 9, wherein the generating of a hash key comprises generating a hash key of the requested file block using hardware acceleration.
